(19) United States
(12) Patent Application Publication
(10) Pub. No.: US 2008/0284165 A1
(43) Pub. Date: Nov. 20, 2008

(54) Universal coupler device

(76) Inventor: Tzai Tien Chiang, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/069,503

(22) Filed: Feb. 11, 2008

(30) Foreign Application Priority Data
May 18, 2007 (TW) 096208099

(51) Int. Cl. F16L 27/04

(52) U.S. Cl. 285/261

(57) ABSTRACT

A universal coupler device includes a housing member having a peripheral flange, a sealing ring engaged in the housing member, a coupler member having a ball portion rotatably received in the housing member, and the peripheral flange is engaged with the ball portion for anchoring the ball portion to the housing member, and a ring member is fitted into the housing member and engaged with the ball portion for anchoring and retaining the ball portion of the coupler member in the housing member, the ring member and the peripheral flange are beveled to form inner rims and to engage with the ball portion for reducing a contact area between the ring member and the peripheral flange and the ball portion.

### BACKGROUND OF THE INVENTION

1. Field of the Invention

The present invention relates to a universal coupler device, and more particularly to a universal coupler device including a reducing contact area between a ball coupler member and an outer cylindrical wall portion and/or a ring member for allowing the ball coupler member to be smoothly rotated relative to the outer cylindrical wall portion and/or the ring member.

2. Description of the Prior Art

Typical universal coupler devices comprise an outer cylindrical wall portion, and a ball coupler member rotatably engaged into and coupled to the outer cylindrical wall portion for allowing the ball coupler member to be selectively rotated relative to the outer cylindrical wall portion to any selected or suitable angular positions.

For example, U.S. Pat. No. 2,936,958 to Shames et al., and U.S. Pat. No. 3,014,665 to Shames et al. disclose two of the typical adaptors or universal couplers each including a casing, and a ball coupler member rotatably coupled or secured to the casing with a coupling nut, and a soft sealing ring engaged into the casing and forced to engage with the ball coupler member with or by the coupling nut.

However, the sealing ring is normally engaged with the lower portion of the ball coupler member, but not the middle portion or the greatest diameter portion of the ball coupler member, and the sealing ring is thus required to be solidly forced toward the ball coupler member with or by the coupling nut. In addition, the sealing ring may not be solidly engaged with the ball coupler member when the coupling nut is not solidly engaged with the casing and the fluid seal between the ball coupler member and the casing will become failed.

The present invention has arisen to mitigate and/or obviate the afore-described disadvantages of the conventional universal coupler devices.

### SUMMARY OF THE INVENTION

The primary objective of the present invention is to provide a universal coupler device including a reducing contact area between a ball coupler member and an outer cylindrical wall portion and/or a ring member for allowing the ball coupler member to be smoothly rotated relative to the outer cylindrical wall portion and/or the ring member.

In accordance with one aspect of the invention, there is provided a universal coupler device comprising a housing member including a chamber formed therein, and including a peripheral flange extended radially and inwardly from a first end of the housing member and beveled to form an inner rim, and including an inner peripheral groove formed in the first end of the housing member, a sealing ring received and engaged in the inner peripheral groove of the housing member, a coupler member including a ball portion rotatably received and engaged in the chamber of the housing member and situated in the first end of the housing member, and including a shank extended from the ball portion and extended out of the chamber of the housing member, and the peripheral flange of the housing member being engaged with the ball portion for anchoring the ball portion to the housing member and for preventing the ball portion from being disengaged from the housing member, and the inner rim of the peripheral flange of the housing member being engaged with the ball portion for reducing a contact area between the housing member and the ball portion of the coupler member, and a ring member fitted into the chamber of the housing member and engaged with the ball portion of the coupler member for anchoring and retaining the ball portion of the coupler member in the housing member, the ring member is beveled to form an inner rim and to engage with the ball portion of the coupler member for reducing a contact area between the ring member and the ball portion of the coupler member and for allowing the ball portion of the coupler member to be smoothly rotated relative to the housing member.

The sealing ring is engaged with a greatest diameter portion of the ball portion of the coupler member to make a fluid tight seal between the ball portion of the coupler member and the housing member.

The housing member includes an inner peripheral groove formed in a second end of the housing member for receiving a second sealing ring, and a second coupler member includes a ball portion rotatably received and engaged in the chamber of the housing member and situated in the second end of the housing member, and the ring member is engaged with the ball portion of the second coupler member for anchoring and retaining the ball portion of the second coupler member in the housing member, and the ring member is beveled to form a second inner rim and to engage with the ball portion of the second coupler member for reducing a contact area between the ring member and the ball portion of the second coupler member.

The second sealing ring is engaged with a greatest diameter portion of the ball portion of the second coupler member to make a fluid tight seal between the ball portion of the second coupler member and the housing member.

A lock member may further be provided and includes a cylindrical wall engaged into the chamber of the housing member and engaged with the ball portion of the second coupler member for forcing the ball portion of the second coupler member to engage with the ring member and thus for stably retaining the ball portion of the second coupler member in the chamber of the housing member.

The housing member includes an inner thread formed in the second end of the housing member, and the lock member includes an outer thread formed on the cylindrical wall for threading and engaging with the inner thread of the housing member and for anchoring and retaining the ball portion of the second coupler member to the housing member.

The cylindrical wall of the lock member is also beveled to form an inner rim and to engage with the ball portion of the second coupler member for reducing a contact area between the cylindrical wall of the lock member and the ball portion of the second coupler member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a universal coupler device in accordance with the present invention;

FIG. 2 is a partial cross sectional view of the universal coupler device;

FIGS. 3 and 4 are further partial cross sectional views illustrating sealing portions of the universal coupler device;

FIG. 5 is a still further partial cross sectional view illustrating the other arrangement of the universal coupler device;

FIG. 6 is a perspective view illustrating the further arrangement of the universal coupler device;

FIG. 7 is another partial exploded view of the universal coupler device as shown in FIG. 6;

FIG. 8 is a partial cross sectional view of the universal coupler device taken along lines 8-8 of FIG. 6; and

FIG. 9 is a further partial cross sectional view illustrating a sealing portion of the universal coupler device as shown in FIGS. 6-8.

### DETAILED DESCRIPTION OF THE PREFERRED EMBODIMENT

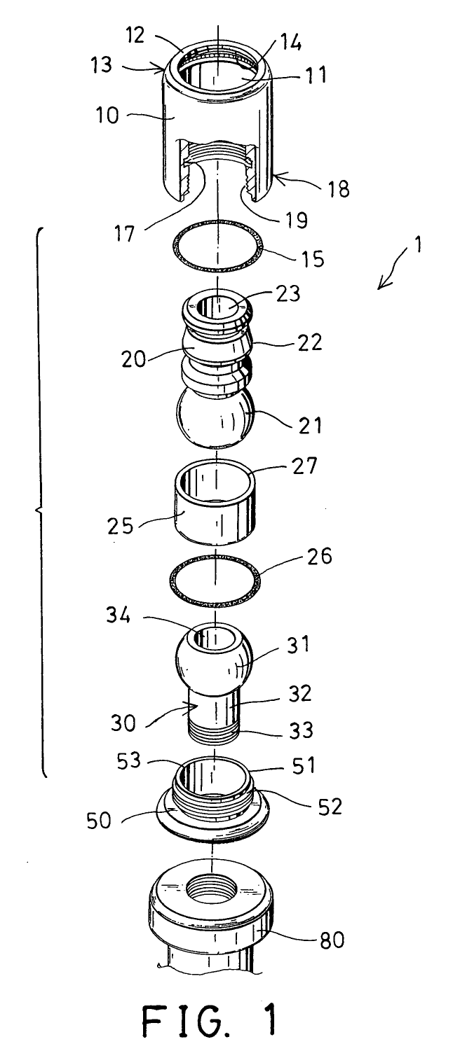

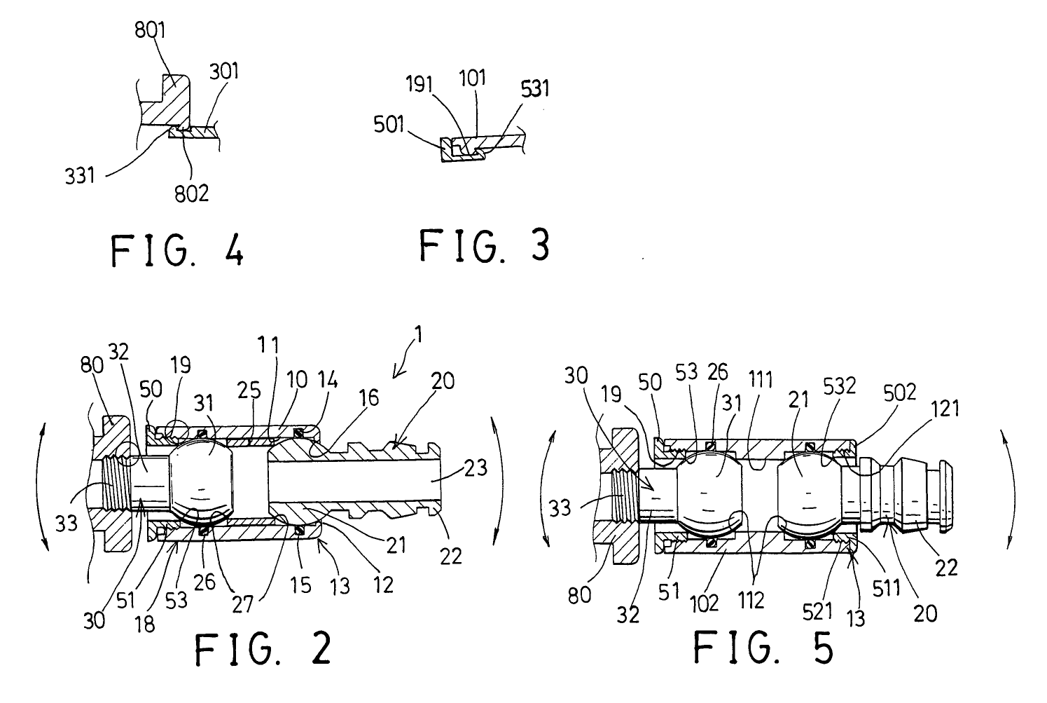

Referring to the drawings, and initially to FIGS. 1 and 2, a universal coupler device 1 in accordance with the present invention comprises an outer cylindrical wall portion or housing member 10 including a chamber 11 formed therein, and including a peripheral flange 12 extended radially and inwardly from one end 13 thereof, and including an inner peripheral groove 14 formed in the one end 13 thereof for receiving or engaging with a sealing ring 15, and including a coupler member 20 having a ball portion 21 pivotally or rotatably received or engaged in the chamber 11 of the housing member 10 and having a shank 22 extended outwardly through the chamber 11 of the housing member 10 for coupling to a pipe or hose member (not shown) or the like.

The coupler member 20 includes a bore 23 formed therein and communicating with the chamber 11 of the housing member 10 (FIG. 2) for allowing a fluid to flow through the bore 23 of the coupler member 20 and to flow between the housing member 10 and the pipe or hose member (not shown). As best shown in FIG. 2, it is preferable that the housing member 10 is beveled on the inner side of the peripheral flange 12 to form an inner rim 16 which is engaged with the ball portion 21 of the coupler member 20 for anchoring and retaining the ball portion 21 of the coupler member 20 to the housing member 10 and for preventing the ball portion 21 of the coupler member 20 from being disengaged from the housing member 10, and also for reducing the contact area between the housing member 10 and the ball portion 21 of the coupler member 20.

It is to be noted that the sealing ring 15 is engaged with the middle portion or the greatest diameter portion of the ball portion 21 of the coupler member 20 and may make a suitable fluid tight seal between the ball portion 21 of the coupler member 20 and the housing member 10 even when the ball portion 21 of the coupler member 20 is slightly moved longitudinally relative to the housing member 10 or when the ball portion 21 of the coupler member 20 is not tightly forced toward or to engage with the inner rim 16 of the peripheral flange 12. A spacer or barrel or ring member 25 is fitted into the chamber 11 of the housing member 10, and preferably snugly fitted or engaged with the inner peripheral portion of the housing member 10, and engaged with the ball portion 21 of the coupler member 20 for further anchoring and retaining and securing the ball portion 21 of the coupler member 20 in the housing member 10.

The housing member 10 further includes another inner peripheral groove 17 formed in the other end portion 18 thereof for receiving or engaging with another sealing ring 26, and includes an inner thread 19 formed in the other end portion 18 thereof. The spacer or barrel or ring member 25 is offset or spaced or disengaged from the sealing rings 15, 26, and situated or located between the sealing rings 15, 26. Another coupler member 30 includes a ball portion 31 pivotally or rotatably received or engaged in the chamber 11 of the housing member 10 and situated or located in the other end portion 18 of the housing member 10, and the ring member 25 may also be engaged with the ball portion 31 of the coupler member 30 for anchoring and retaining the ball portion 31 of the coupler member 30 in the housing member 10, and the ring member 25 is beveled on the inner sides to form two inner rims 27 which are engaged with the ball portion 21, 31 of the coupler member 20, 30 for reducing the contact area between the ring member 25 and the ball portions 21, 31 of the coupler members 20, 30 and for allowing the ball portion 21, 31 of the coupler member 20, 30 to be smoothly rotated relative to the housing member 10.

The coupler member 30 also includes a shank 32 extended from the ball portion 31 and extended outwardly through the chamber 11 of the housing member 10 for coupling to another pipe or hose member 80 with such as an outer thread 33 or the like, and also includes a bore 34 formed therein and communicating with the chamber 11 of the housing member 10 for allowing the fluid to flow through the bore 34 of the coupler member 30 and to flow between the housing member 10 and the pipe or hose member 80. A lock member 50 includes a cylindrical wall 51 for engaging into the chamber 11 of the housing member 10 and having an outer thread 52 formed on the outer peripheral portion of the cylindrical wall 51 for threading or engaging with the inner thread 19 of the housing member 10 and for anchoring and retaining the ball portion 31 of the coupler member 30 to the housing member 10.

For example, the cylindrical wall 51 of the lock member 50 may be engaged into the chamber 11 of the housing member 10 for engaging with the ball portion 31 of the coupler member 30 and for forcing the ball portion 31 of the coupler member 30 to engage with the ring member 25, and thus for stably retaining the ball portion 31 of the coupler member 30 in the chamber 11 of the housing member 10. It is further preferable that the lock member 50 is also beveled on the inner side of the cylindrical wall 51 to form an inner rim 53 which is engaged with the ball portion 31 of the coupler member 30 for anchoring and retaining the ball portion 31 of the coupler member 30 to the housing member 10 and for reducing the contact area between the cylindrical wall 51 of the lock member 50 and the ball portion 31 of the coupler member 30.

Alternatively, as shown in FIG. 3, without the inner thread 19 of the housing member 10 and the outer thread 52 of the lock member 50, the housing member 101 may include a catch 191 extended radially and inwardly therefrom, and the lock member 501 may include another catch 531 extended radially and outwardly therefrom for engaging with the catch 191 of the housing member 101 and for locking or securing the lock member 501 to the housing member 10. Further alternatively, as shown in FIG. 4, without the outer thread 33 of the coupler member 30, the pipe or hose member 801 may include a catch 802 extended radially and inwardly therefrom, and the coupler member 301 may include another latch or catch 331 extended radially and outwardly therefrom for engaging with the catch 802 of the pipe or hose member 801 and for locking or securing the coupler member 301 to the pipe or hose member 801.

Further alternatively, as shown in FIG. 5, the housing member 102 may include an inner thread 121 formed in the end portion 13 thereof for threading or engaging with the outer thread 521 of another lock member 502 which is also beveled on the inner side of the cylindrical wall 511 to form an inner rim 532 which is engaged with the ball portion 21 of the coupler member 20 for anchoring and retaining the ball portion 21 of the coupler member 20 to the housing member 102 and for reducing the contact area between the cylindrical wall 511 of the lock member 502 and the ball portion 21 of the coupler member 20. The housing member 102 may include an inner peripheral swelling 111 extended radially and inwardly from the middle portion thereof and beveled on the inner sides to form two inner rims 112 which are engaged with the ball portion 21, 31 of the coupler member 20, 30 for reducing the contact area between the peripheral swelling 111 and the ball portions 21, 31 of the coupler members 20, 30.

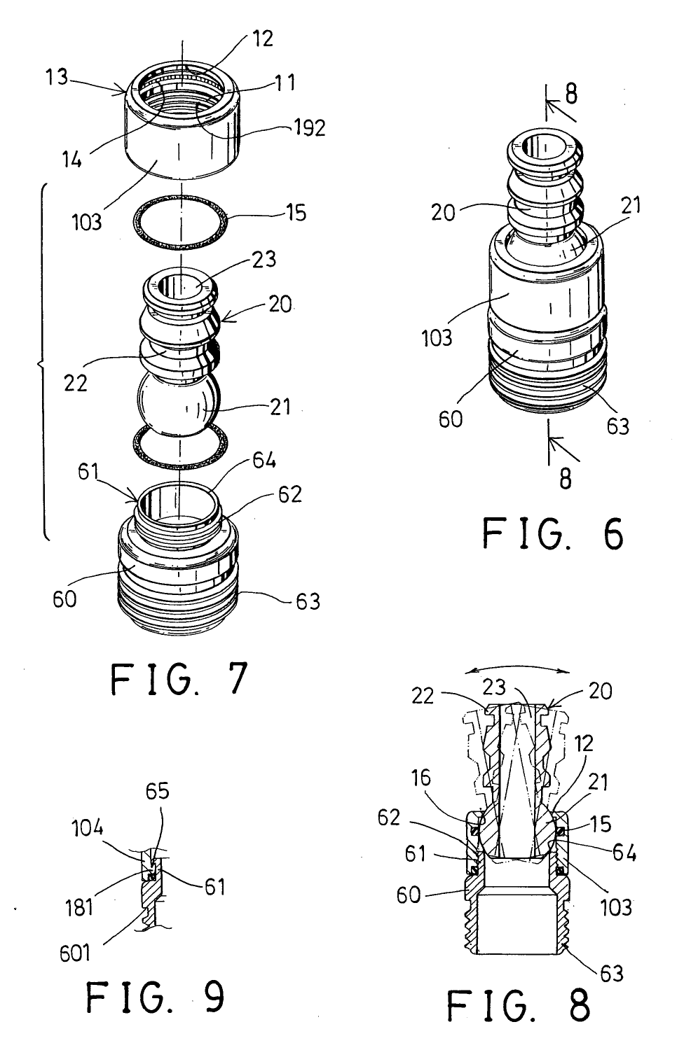

Further alternatively, as shown in FIGS. 6-8, the housing member 103 may include an inner thread 192 formed in the end portion 13 thereof, and a tubular member 60 includes a cylindrical fence 61 extended outwardly therefrom and having an outer thread 62 formed on the outer peripheral portion of the cylindrical fence 61 for threading or engaging with the inner thread 192 of the housing member 103 and for anchoring and retaining the ball portion 21 of the coupler member 20 to the housing member 103. The tubular member 60 may include an outer thread 63 formed thereon for threading or engaging with the inner thread of the other pipe or hose members (not shown), and may also be beveled on the inner side of the cylindrical fence 61 to form an inner rim 64 which is engaged with the ball portion 21 of the coupler member 20 for reducing the contact area between the peripheral fence 61 and the ball portion 21 of the coupler member 20.

Further alternatively, as shown in FIG. 9, the housing member 104 may include a catch 181 extended radially and inwardly therefrom, and the tubular member 601 may include another catch 65 extended radially and outwardly from the peripheral fence 61 for engaging with the catch 181 of the housing member 104 and for locking or securing the tubular member 601 to the housing member 104.

Accordingly, the universal coupler device in accordance with the present invention includes a reducing contact area between a ball coupler member and an outer cylindrical wall portion for allowing the ball coupler member to be smoothly rotated relative to the outer cylindrical wall portion.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A universal coupler device comprising:
a housing member including a chamber formed therein, and including a peripheral flange extended radially and inwardly from a first end of said housing member and beveled to form an inner rim, and including an inner peripheral groove formed in said first end of said housing member,
a sealing ring received and engaged in said inner peripheral groove of said housing member,
a coupler member including a ball portion rotatably received and engaged in said chamber of said housing member and situated in said first end of said housing member, and including a shank extended from said ball portion and extended out of said chamber of said housing member, and said peripheral flange of said housing member being engaged with said ball portion for anchoring said ball portion to said housing member and for preventing said ball portion from being disengaged from said housing member, and said inner rim of said peripheral flange of said housing member being engaged with said ball portion for reducing a contact area between said housing member and said ball portion of said coupler member, and
a ring member fitted into said chamber of said housing member and engaged with said ball portion of said coupler member for anchoring and retaining said ball portion of said coupler member in said housing member, said ring member being beveled to form an inner rim and to engage with said ball portion of said coupler member for reducing a contact area between said ring member and said ball portion of said coupler member.

2. The universal coupler device as claimed in claim 1, wherein said sealing ring is engaged with a greatest diameter portion of said ball portion of said coupler member to make a fluid tight seal between said ball portion of said coupler member and said housing member.

3. The universal coupler device as claimed in claim 1, wherein said housing member includes an inner peripheral groove formed in a second end of said housing member for receiving a second sealing ring, and a second coupler member includes a ball portion rotatably received and engaged in said chamber of said housing member and situated in said second end of said housing member, and said ring member is engaged with said ball portion of said second coupler member for anchoring and retaining said ball portion of said second coupler member in said housing member, and said ring member is beveled to form a second inner rim and to engage with said ball portion of said second coupler member for reducing a contact area between said ring member and said ball portion of said second coupler member.

4. The universal coupler device as claimed in claim 3, wherein said second sealing ring is engaged with a greatest diameter portion of said ball portion of said second coupler member to make a fluid tight seal between said ball portion of said second coupler member and said housing member.

5. The universal coupler device as claimed in claim 3, wherein a lock member includes a cylindrical wall engaged into said chamber of said housing member and engaged with said ball portion of said second coupler member for forcing said ball portion of said second coupler member to engage with said ring member and for retaining said ball portion of said second coupler member in said chamber of said housing member.

6. The universal coupler device as claimed in claim 5, wherein said housing member includes an inner thread formed in said second end of said housing member, and said lock member includes an outer thread formed on said cylindrical wall for threading and engaging with said inner thread of said housing member and for anchoring and retaining said ball portion of said second coupler member to said housing member.

7. The universal coupler device as claimed in claim 5, wherein said cylindrical wall of said lock member is beveled to form an inner rim and to engage with said ball portion of said second coupler member for reducing a contact area between said cylindrical wall of said lock member and said ball portion of said second coupler member.

8. A universal coupler device comprising:
a housing member including a chamber formed therein, and including an inner peripheral swelling extended radially and inwardly from a middle portion and beveled to form an inner rim, and including a peripheral groove formed in said first end of said housing member,
a sealing ring received and engaged in said inner peripheral groove of said housing member,
a coupler member including a ball portion rotatably received and engaged in said chamber of said housing member and situated in said first end of said housing member, and including a shank extended from said ball portion and extended out of said chamber of said housing member, and said inner rim of said inner peripheral swelling of said housing member being engaged with said ball portion for reducing a contact area between said housing member and said ball portion of said coupler member, and
a lock member including a cylindrical wall engaged into said first end of said housing member and engaged with said ball portion of said coupler member for retaining said ball portion of said coupler member in said chamber of said housing member, and said cylindrical wall of said lock member is beveled to form an inner rim and to engage with said ball portion of said coupler member for reducing a contact area between said cylindrical wall of said lock member and said ball portion of said coupler member.

9. The universal coupler device as claimed in claim 8, wherein said housing member includes an inner thread formed in said first end of said housing member, and said lock member includes an outer thread formed on said cylindrical wall for threading and engaging with said inner thread of said housing member and for anchoring and retaining said ball portion of said coupler member to said housing member.

10. The universal coupler device as claimed in claim 8, wherein said sealing ring is engaged with a greatest diameter portion of said ball portion of said coupler member to make a fluid tight seal between said ball portion of said coupler member and said housing member.
